(19) United States
(12) Patent Application Publication
(10) Pub. No.: US 2008/0129849 A1
(43) Pub. Date: Jun. 5, 2008

(54) Imaging Device and Imaging Method

(75) Inventors: Yasuaki Inoue, Osaka (JP); Yoshinao Hiranuma, Osaka (JP); Kyoichi Takano, Tokyo (JP); Tomohiro Kuroda, Osaka (JP)

Correspondence Address: NDQ&M WATCHSTONE LLP, 1300 EYE STREET, NW, SUITE 1000 WEST TOWER, WASHINGTON, DC, 20005, US

(73) Assignees: Sanyo Electric Co.ltd, Osaka (JP); Kyoto University, Kyoto (JP)

(21) Appl. No.: 11/663,835

(22) PCT Filed: Sep. 27, 2005
(86) PCT No.: PCT/JP05/17782

§ 371 Date: Jun. 26, 2007

(30) Foreign Application Priority Data
Sep. 28, 2004 (JP) 2004-281001

(51) Int. Cl. H04N 9/07

(52) U.S. Cl. 348/266

(57) ABSTRACT

A file is prepared by bringing patient ID and a photograph of affected parts into correspondence with each other.

An image pickup unit takes an image of bar code. An ID extraction unit extracts an ID from the image taken of the bar codes. A communication unit acquires entity information corresponding to the ID, from an external database. The IDs and entity information are displayed to a user. The user acquires an affected-part image from the image pickup unit. An affected-part file generation unit generates an affected-part file where ID and a photograph of an affected part are brought into correspondence with each other. The communication unit transmits the affected-part file to an external file database on patients.

### TECHNICAL FIELD

The present invention relates to an image pickup technology and particularly relates to a technology for recording an object and information related thereto in such a manner that they are associated with each other.

### BACKGROUND TECHNOLOGY

Bar codes are widely used to identify a variety of information. The bar codes are, in a sense, a graphic representation of numerical information according to predetermined rules. Recently, a bar code called a two-dimensional code, which holds information both vertically and horizontally, is beginning to see wider use.

In places for medical services, too, the bar codes are widely used to identify the patients, physicians, nurses, medicines, and the like. There are many hospitals at which patients' files are managed based on the IDs represented by these bar codes.

Patent Document 1 discloses an invention for managing photographs of affected parts based on bar codes. In an embodiment of the invention, a user has a bar code reader for reading a bar code representing a patient ID. The patient ID thus read is once stored in a computer, such as a personal computer. This computer acquires patient information corresponding to a stored patient ID from a medical database. The user loads the patient information from the computer into the camera. Upon confirmation thereof, the user takes a photograph of an affected part of the patient corresponding to the patient ID. The patient ID is embedded as header information in the image file of the photograph of the affected part, and this file is transmitted from the camera to an external database. Thus it is easy to make a record with an assured correspondence between the patient ID and the photograph of the affected part (see Patent Document 1).

### [Patent Document 1]

Japanese Patent Application Laid-Open No. 2002-232761.

According to the embodiment of such invention, however, the user should operate three pieces of equipment, namely, a bar code reader, a camera, and a personal computer, by a predetermined procedure. Therefore, its user interface is complicated, and as a result operation errors are more likely to happen. Especially in places for medical services, where any mix-up of affected part images can lead to a consequence of fatality, it is particularly important to ensure accurate correspondence between patient IDs and affected part photographs. Accordingly, the present inventors came to realize that it is necessary to provide a mechanism by which to ensure the certainty of correspondence between the ID and the photograph of a subject, instead of entrusting it to user management.

### DISCLOSURE OF THE INVENTION

The present invention has been made in view of the problems as described above, and a main purpose thereof is to provide a technology for recording a subject image and information related to said subject in a manner that associates the image with the information by the use of a simple interface.

An image pickup apparatus, according to one embodiment of the present invention, picks up an image of a graphic indicative of ID information based on a predetermined rule so as to identify the ID information, and receives, from an external database, entity information corresponding to the ID information so as to display it on a screen. Upon confirmation of the entity information, a user takes an image of a corresponding subject. Then, the image pickup apparatus records subject information that associates an image of the subject with both or either of the ID information and the entity information.

According to this embodiment, the user can acquire IDs by use of a general-purpose image pickup apparatus such as a digital camera instead of an exclusive-use apparatus such as a bar code reader. As a result, the user can acquire information where two objects, namely, a graphic and a subject are associated with each other, by merely taking the images of these two objects. The entity information is information associated with the ID information. For example, the entity information may be attribute information such as patient names and medical conditions. In what is to follow, “image pickup” means that a photographic apparatus takes in the image of a subject as image information, whereas “taking an image” means determining the image of a subject and then recording it in a recording medium as an image file.

### EFFECTS OF THE INVENTION

The present invention is advantageous in that an image of a subject and information related to the subject are recoded by bringing them into correspondence with each other.

### BRIEF DESCRIPTION OF THE DRAWINGS

FIG. 1 is a schematic depiction for explaining an operation of a digital camera.

FIG. 2 is a block diagram showing functions of a digital camera.

FIG. 3 is an arrangement plan of base stations in a hospital.

FIG. 4 is a data structure diagram of an ID storage unit in a digital camera.

FIG. 5 is a data structure diagram of a schedule database.

FIG. 6 is a flowchart showing processes for generating an affected part file.

FIG. 7 is a flowchart showing in detail a validity decision processing in S12 in FIG. 6.

### DESCRIPTION OF REFERENCE NUMERALS

100 digital camera, 102 ID card, 104 bar code, 106 ID database, 107 schedule database, 110 affected part file database, 120 image pickup unit, 130 ID management unit, 132 ID extraction unit, 134 ID storage unit, 136 validity decision unit, 140 display unit, 142 image buffer processing unit, 144 display processing unit, 146 monitor display unit, 148 on-screen item buffer processing unit, 150 control unit, 152 affected part file generation unit, 154 time management unit, 156 time acquisition unit, 158 differential time calculation unit, 162 position management unit, 164 position acquisition unit, 166 differential distance calculation unit, 170 operation unit, 172 communication unit

### THE BEST MODE FOR CARRYING OUT THE INVENTION

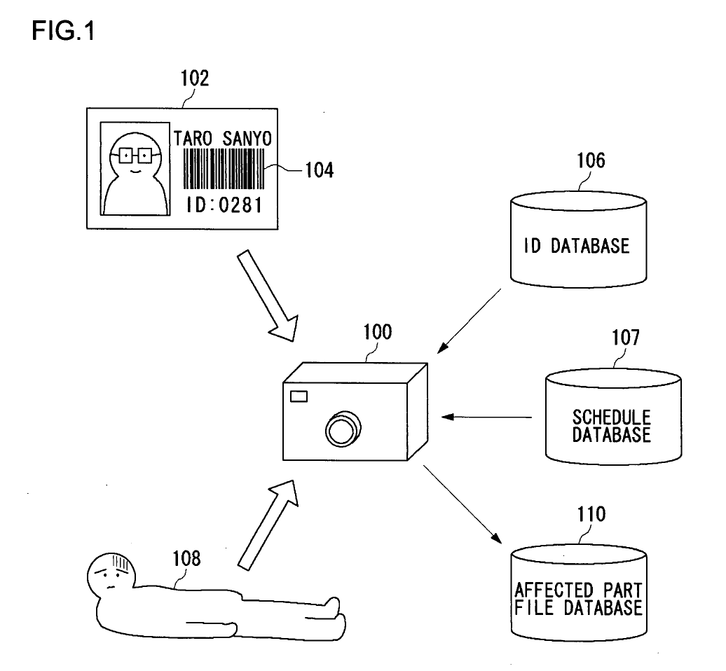

FIG. 1 is a schematic depiction for explaining an operation of a digital camera 100.

An ID card 102 includes a bar code 104. The bar code 104 shows a physician ID for identifying a physician. In the figure, the ID card 102 is a card for identifying a physician named “Taro Sanyo”, and the physician ID is “0281”. It is supposed herein that “Taro Sanyo” is the user of the digital camera 100, or the image taker.

As listed below, the processing in this embodiment can be roughly divided into the following seven processes:

(1) Firstly, the user takes an image of the bar code 104 on the ID card 102 so as to identify himself or herself.

(2) The digital camera 100 detects the physician ID “0281” from the image taken of the bar code 104.

(3) The digital camera 100 receives information on the physician corresponding to the physician ID “0281” (hereinafter referred to as “physician information”) from an ID database 106. The physician information refers to information related to the physician, such as the name of the physician and the medical department he/she belongs to. Hereinbelow, the information available from the ID database 106 relative to the ID like this is collectively called “entity information”. The entity information herein is no different from physician information.

(4) The digital camera has all or part of the physician information received from the ID database 106 displayed on a finder screen.

(5) Upon confirming the physician information displayed, the user takes an image of the affected part of the patient 108.

(6) The digital camera 100 brings the physician ID “0281” and the affected part image of a patient 108 into correspondence with each other. The digital camera 100 may bring into correspondence the physician information in place of the physician ID. Hereinbelow, a file generated by bringing an ID, such as a physician ID, or entity information, such as physician information, and an affected part image into correspondence with each other is called an “affected part file”.

(7) The digital camera 100 transmits the affected part file to the affected part file database 110.

In this manner, it is possible to record an affected part image and a user, who is the taker of the image, in a manner that associates the affected part image with the user. In other words, the user can generate an affected part file based on correspondence between information available from two images simply by taking the images of a bar code 104 and an affected part of the patient 108.

Here, a description has been given of a case where a physician ID is acquired to identify the image taker, and the same is true for the acquisition of a patient ID to identify the patient. In such a case, it is possible to generate an affected part file based on a correspondence between the patient ID or the patient information, which is acquired from the ID database 106 relative to the patient ID, and the affected part image. The physician ID and the patient ID, or the entity information related thereto may be combined together to create a patient file. The schedule database 107 shown in the figure is a database for management of the schedule of the image taker. The schedule database 107, which is a database that the digital camera 100 utilizes principally to determine the validity of an ID, will be described in detail later.

The digital camera 100, the ID database 106, the schedule database 107, and the affected part file database 110 may transmit and receive data via a predetermined communication network, such as the Internet, or may transmit and receive data via a wireless LAN (Local Area Network) which is standardized by IEEE 802.11 or the like.

The digital camera 100 may display the ID or the entity information on, for instance, an external display unit, instead of the finder screen. The digital camera 100 may record the affected part file in a built-in recording medium, instead of the affected part file database 110. Or the digital camera 100 may have a built-in database itself, which is equivalent to the ID database 106.

The affected part file may be generated as a file set combining an affected part image file with a file showing the ID or a file showing the entity information. Or the affected part file may be generated with an ID or entity information embedded as an image in an affected part image. The embedding at this time may be accomplished by superimposing the text data as an image on the affected part image or by a mode of embedding such that the visual recognition by the user is restricted as in electronic watermarking.

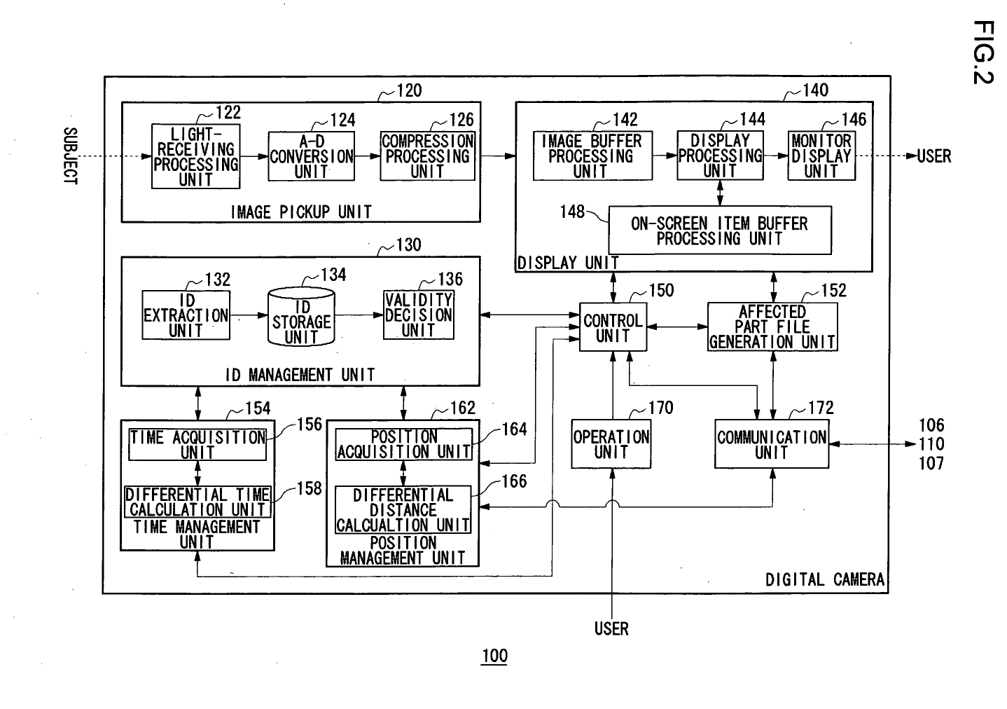

FIG. 2 is a block diagram showing functions of the digital camera 100. In terms of hardware, each block shown here can be realized by elements like a CPU of a computer or mechanical devices. In terms of software, it is realized by computer programs, but drawn herein are function blocks that are realized in cooperation with those. Thus, it is understood by those skilled in the art that these function blocks can be realized in a variety of forms such as by hardware only, software only or the combination thereof.

The digital camera 100 includes an image pickup unit 120, a display unit 140, an ID management unit 130, a time management unit 154, a position management unit 162, an affected part file generation unit 152, an operation unit 170, a communication unit 172, and a control unit 150.

The image pickup unit 120 picks up the image of a subject. The display unit 140 displays to the user a variety of information, including the image of the subject, which has been acquired through the image pickup unit 120. The ID management unit 130 manages the ID represented by a bar code 104. The time management unit 154 performs management concerning time. The position management unit 162 performs management concerning the position of the digital camera 100. The affected part file generation unit 152 generates an affected part file. The operation unit 170 receives various operations from the user. The communication unit 172 is in charge of communications with the ID database 106, the schedule database 107, and the affected part file database 110. The communication unit 172 also carries out communications with a base station which has the position of the digital camera 100 as a cell region. The control unit 150 performs an overall control of these blocks in response to the operations from the user mainly through the operation unit 170.

The image pickup unit 120 includes a light-receiving processing unit 122, an A-D conversion unit 124, and a compression processing unit 126.

The light-receiving processing unit 122 forms an image by taking in the light from a subject and converts the formed image into electrical signals. The light-receiving processing unit 122 includes a lens and a CCD (Charge Coupled Device), which are not shown. The A-D conversion unit 124 performs A-D conversion of these electrical signals. The compression processing unit 126 carries out compression processing on the A-D-converted image data of the subject.

The display unit 140 includes an image buffer processing unit 142, a display processing unit 144, a monitor display unit 146, and an on-screen item buffer processing unit 148.

The image buffer processing unit 142 temporarily stores a subject image outputted by the image pickup unit 120. The image buffer processing unit 142 includes a RAM which temporarily stores the data of a still image or a moving image compressed by JPEG (Joint Photographic Experts Group) scheme or MPEG (Moving picture Experts Group) scheme. Further, the image buffer processing unit 142 also holds the subject image while having it displayed on the monitor display unit 146. The on-screen item buffer processing unit 148 stores an icon and text to be displayed superimposed on the image held by the image buffer processing unit 142. The icon and text meant here are not limited to those prepared in advance in the digital camera 100, but they may include the ID represented by a bar code 104 and entity information acquired from the ID database 106 in correspondence thereto.

The display processing unit 144 determines a display layout and superimposes the plane of a subject image held by the image buffer processing unit 142 and the plane of an icon and text held by the on-screen item buffer processing unit 148. The monitor display unit 146 has display data displayed on the monitor screen, following the instructions from the display processing unit 144. The monitor display unit 146 includes an LCD (Liquid Crystal Display).

The ID management unit 130 includes an ID extraction unit 132, an ID storage unit 134, and a validity decision unit 136.

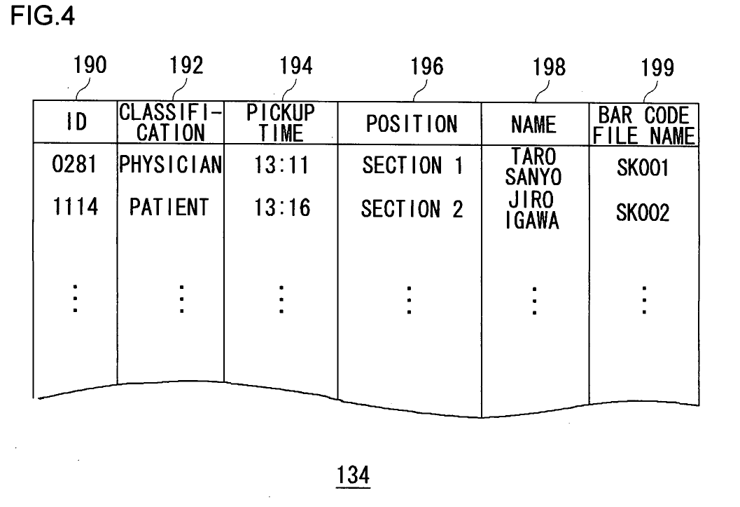

When an image of a bar code 104 is taken by the image pickup unit 120, the image is temporarily stored in the image buffer processing unit 142. The control unit 150 instructs the ID extraction unit 132 to extract an ID from the image of the bar code 104. The ID extraction unit 132 extracts the ID from the bar code, which is graphic information. The ID extraction unit 132 stores the extracted ID in the ID storage unit 134. The communication unit 172 acquires entity information corresponding to this ID from the ID database 106 and stores it in the ID storage unit 134 in correspondence to the ID. The ID storage unit 134 also stores information concerning the ID acquisition time and place acquired from the time management unit 154 and the position management unit 162 as well as the image information of the bar code itself image-taken by the image pickup unit 120. The data structure of the ID storage unit 134 will be described in detail later in connection with FIG. 4.

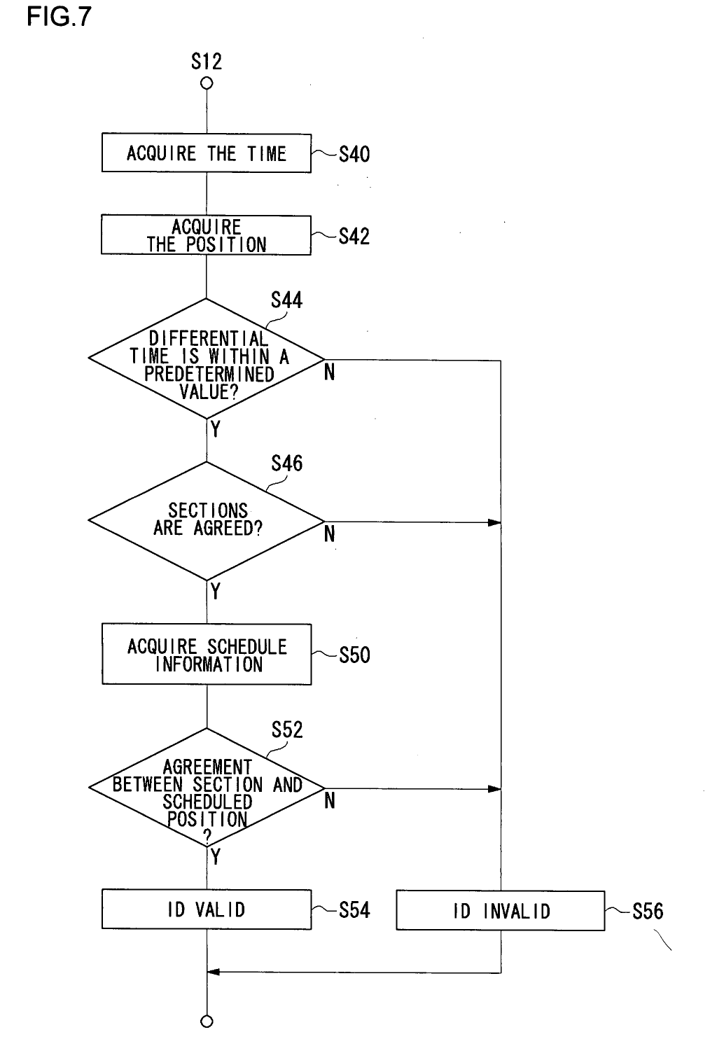

The validity decision unit 136 decides whether the affected part file generation unit 152 can generate an affected part file or not, based on the ID stored by the ID storage unit 134. The validity decision unit 136 carries out a decision processing like this to prevent any mistaken correspondence between an old ID stored in the ID storage unit 134 and a newly acquired patient image, for instance. This validity decision processing will be described in detail later particularly in connection with the flowchart of FIG. 7.

The time management unit 154 includes a time acquisition unit 156 and a differential time calculation unit 158.

The time acquisition unit 156 acquires time. The differential time calculation unit 158 calculates the time difference between the image-taken time of the bar code 104 and the present time as a differential time. The differential time calculation unit 158 may also calculate the time difference between the time at which the ID extraction unit 132 extracted the ID and the present time as a differential time. The validity decision unit 136 decides on a reacquisition of the ID if the differential time is longer than a predetermined value at the image-taken time of the affected part image. That is, when the time between the acquisition of an ID and the acquisition of an affected part image is long, a step is taken such that an affected part file combining these is not generated. This is done on the premise that the acquisition of an ID and the acquisition of an affected part image are normally carried out in a series of operations.

The position management unit 162 includes a position acquisition unit 164 and a differential distance calculation unit 166.

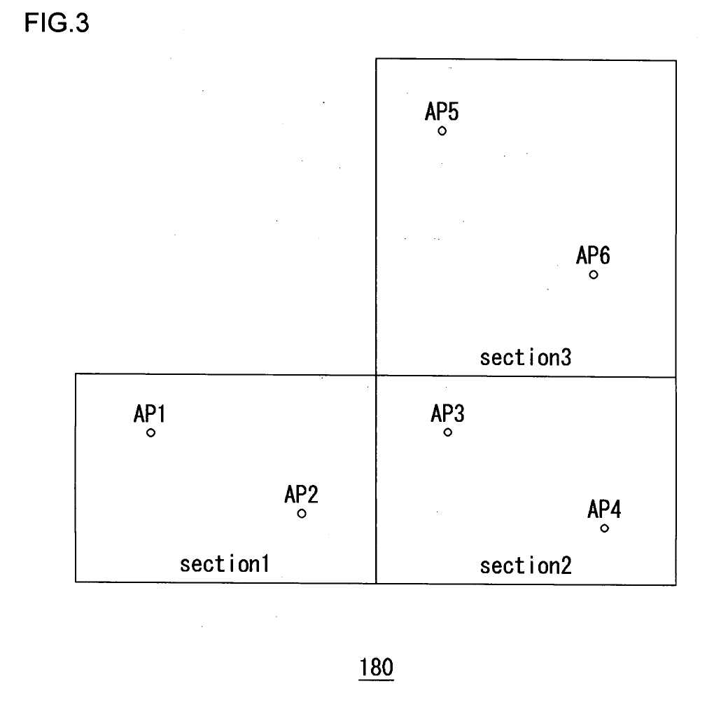

The position acquisition unit 164 acquires the present position of the digital camera 100. The position acquisition unit 164 according to the present embodiment has the communication unit 172 detect a base station in charge of the cell region where the digital camera 100 is located. And the area where the base station exists (hereinafter referred to as “section”; the details will be described later in FIG. 3.) is acquired as the present position of the digital camera 100. Note that the position acquisition unit 164 may detect the present position of the digital camera 100 by a position detecting means such as GPS (Global Positioning System).

The differential distance calculation unit 166 calculates the distance between the image-taken position of a bar code 104 and the present position as a differential distance. The differential distance calculation unit 166 in the present embodiment determines the relative size of differential distance based on whether or not there is agreement between the section at the image-taken time of the bar code 104 and the present section. The differential distance calculation unit 166 may also calculate the distance between the position of the digital camera when an ID is extracted by the ID extraction unit 132 and the present position as a differential distance.

The validity decision unit 136 decides on a reacquisition of an ID if the differential distance is longer than a predetermined value at the image-taken time of an affected part image. According to the present embodiment, if there is no agreement between the section when an ID is acquired and the section when an affected part image is acquired, the validity decision unit 136 decides on a reacquisition of an ID for the reason that “the differential distance is greater than or equal to a predetermined value”. That is, when there is no agreement between the place of ID acquisition and the place of affected part image acquisition or when the places are apart from each other by a certain threshold value or more, a step is taken such that an affected part file combining these is not generated. This is done also on the premise that the acquisition of an ID and the acquisition of an affected part image are normally carried out in a series of operations.

FIG. 3 is an arrangement plan of base stations in a hospital 180.

In the hospital 180, base stations are placed in six positions shown as AP1 to AP6. Of these, AP1 and AP2 are included in an area called section 1. Similarly, AP3 and AP4 are included in section 2, and AP5 and AP6 in section 3. The sections may be set, for instance, for different wards or medical departments.

The communication unit 172 makes a connection to a base station which has a cell region where the digital camera 100 exists. The communication unit 172 acquires a MAC (Media Access Control) address of the base station, which is the access point. The position acquisition unit 164 accesses a not-shown external database via the communication unit 172 and detects a section where the base station belongs, based on the above-mentioned MAC address. This database is a database with correspondence between the MAC addresses of the respective base stations and the sections where those base stations belong. In this manner, the position acquisition unit 164 can easily identify the present position in terms of section.

FIG. 4 is a data structure diagram of an ID storage unit 134.

An ID column 190 shows IDs. The classification column 192 shows classification of entity information corresponding to ID. The image-taken time column 194 shows the time of image-taking of a bar code 104. The ID storage unit 134 may store the time of ID extraction in addition to the time of image-taking of a bar code 104. The position column 196 shows the section where the digital camera 100 is located at the image-taken time of a bar code 104. The ID storage unit 134 may store information on the section where the digital camera 100 is located at the time of ID extraction. A name column 198 shows entity information corresponding to the ID column 190. Shown in the same figure are the names of a physician and a patient corresponding to the IDs. A bar code file name column 199 shows the image file name of each corresponding bar code.

In the same figure, the ID storage unit 134 has in storage the respective IDs of a physician and a patient. In the same figure, the bar code 104 of physician “Taro Sanyo” of physician ID “0281” was image-taken in section 1 at “13:11”. The bar code 104 of patient “Jiro Igawa” of patient ID “1114” was image-taken in section 2 at “13:16”.

When the validity of these IDs is acknowledged by the validity decision unit 136, an affected part file is generated by combining these IDs or entity information with the affected part image. When the validity is not acknowledged or when an instruction is given expressly by the user, a reacquisition of an ID or entity information is carried out.

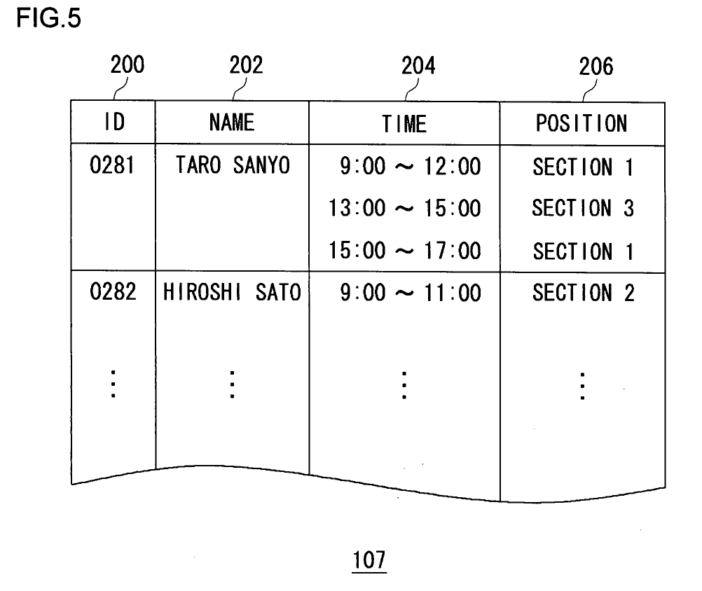

FIG. 5 is a data structure diagram of a schedule database 107.

The schedule database 107 is a database for managing the schedule of physicians, patients, and the like. The ID column 200 shows IDs. The name column 202 shows the names of corresponding physicians and patients as entity information corresponding to the IDs. The time column 204 shows the times. The position column 206 shows the places scheduled at the times shown in the time column 204. For example, physician “Taro Sanyo” of physician ID “0281” is scheduled to attend to patients in “section 1” during the period “9:00-12:00”.

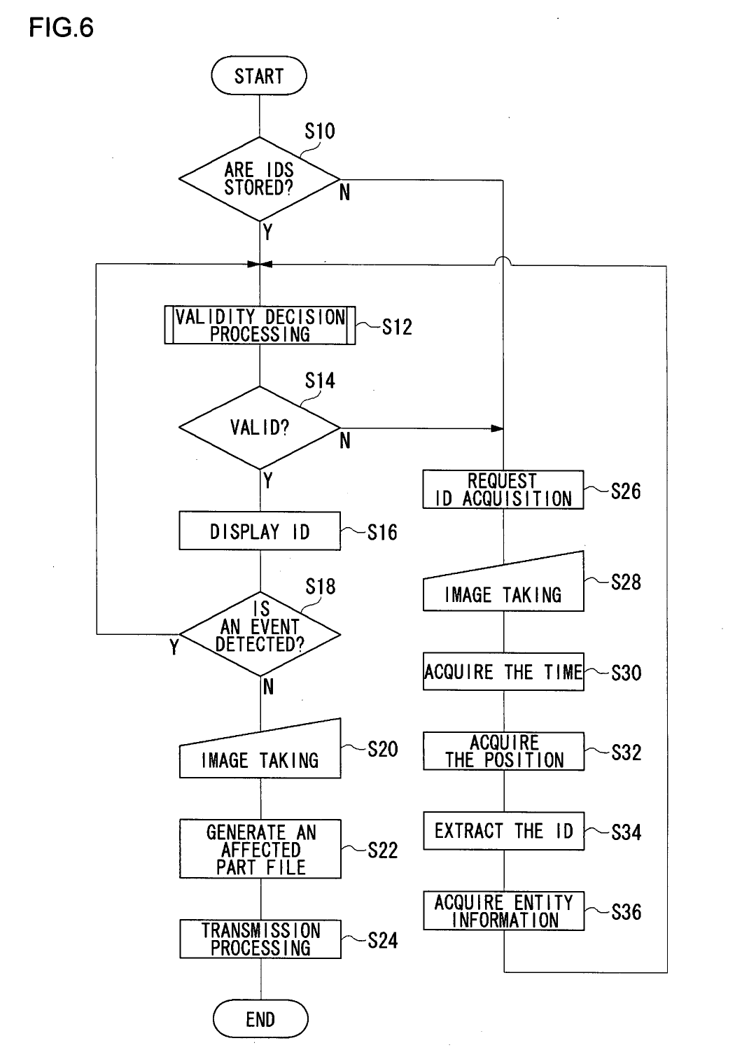

FIG. 6 is a flowchart showing the processes for generating an affected part file.

After the power to the digital camera 100 is turned on and an initialization process is completed, the processes as shown in the flowchart are carried out. In the initialization process, the time acquisition unit 156 acquires the present time. The position acquisition unit 164 detects the section where the digital camera 100 is located as the present position of the digital camera 100.

The validity decision unit 136 firstly decides whether the physician ID and the patient ID are stored in the ID storage unit 134 or not (S10). If these IDs are in storage (Y of S10), the validity decision unit 136 executes a validity decision process to determine the validity of those IDs (S12). A validity decision process is a process for determining whether or not the ID stored in the ID storage unit 134 can be brought into correspondence to the affected part image in order to generate an affected part file. The specific description will be given in detail in connection with FIG. 7.

If the ID is decided to be valid (Y of S14), the control unit 150 instructs the display processing unit 144 to have the ID and entity information stored in the ID storage unit 134 displayed on the monitor display unit 146 (S16). At this time, if an event flag is on as a result of a temporal event caused by the time acquisition unit 156 at every passage of a certain time or a movement event caused by the position acquisition unit 164 on each occasion of handover (Y of S18), the processing will return to S12 and a validity decision process will be executed again. Without such an event occurring (N of S18), the user takes the image of the affected part of the patient 108 (S20).

The affected part file generation unit 152 generates an affected part file as an image file embedding an ID which has been decided to be valid for the affected part image (S22). The communication unit 172 transmits this affected part file to the affected part file database 110 (S24). In S22, the time of generation of the affected part file, the information on the position of the digital camera 100 at the time of generation thereof, and the image information of the bar code itself image-taken by the image pickup unit 120 may be further embedded in the affected part file.

When the ID is not in storage in the ID storage unit 134 (N of S10) or when the ID in storage is not decided to be valid (N of S14), the control unit 150 instructs the display processing unit 144 to have the monitor display unit 146 display an instruction requiring an image-taking to acquire the ID (S26) . In response to this instruction, the user takes an image of the bar code 104 (S28). The image of the bar code 104 taken by the image pickup unit 120 is temporarily held in the image buffer processing unit 142.

Upon this, the time acquisition unit 156 acquires the present time as instructed by the control unit 150 (S30). The position acquisition unit 164 acquires the present position as instructed by the control unit 150 (S32). The ID extraction unit 132 extracts an ID from the image information of the bar code 104 held in the image buffer processing unit 142 (S34). The control unit 150 instructs the communication unit 172 to acquire entity information corresponding to the extracted ID from the ID database 106 (S36). These ID information and entity information are stored in a data structure as shown in FIG. 4 in the ID storage unit 134, and the processing returns to S12.

Note that the user can interrupt these processes by way of the operation unit 170. User operation is executed by a thread of higher priority, and the processes shown in the figure represent a case where the user keeps on the operation of generating an affected part file. Note also that the same flowchart shows the processes for generating an affected part file and that the user can also take the image of a subject by using the digital camera 100 as an ordinary camera.

FIG. 7 is a flowchart showing in detail the validity decision processing in S12 in FIG. 6.

Firstly, the time acquisition unit 156 acquires the present time (S40). The position acquisition unit 164 detects the section where the digital camera 100 belongs as the present position (S42). The differential time calculation unit 158 calculates the differential time and determines whether or not the differential time is less than or equal to a predetermined value, e.g., five minutes (S44). When the differential time exceeds this predetermined value (N of S44), the validity decision unit 136 decides the ID to be invalid (S56) . The differential time may be a time difference between the image taken time of the bar code 104 indicating the ID and the time acquired in S40 or may be a time difference between the time of ID extraction and the time acquired in S44. Moreover, it may be a time difference between the image-taken time of the affected part image taken the most recently and the time acquired in S44.

When the differential time is less than or equal to the predetermined value (Y of S44), a decision is made as to whether the differential distance is less than or equal to a predetermined value. The differential distance may be decided based on the actual distance, but, according to the present embodiment, a decision is made based on whether or not there is agreement between the section at the image-taking of an ID and the present section (S46). When there is no agreement in section (N of S46), the validity decision unit 136 decides the ID to be invalid (S56). A decision based on a differential distance may be made based on the distance between the position of the digital camera 100 at the image-taking of the bar code 104 and the position acquired in S42 or may be made based on the distance between the position of ID extraction and the position acquired in S42. Or it may be made based on the distance between the position of the most recent pickup of an affected part image and the position acquired in S42.

When there is agreement in section (Y of S46), the control unit 150 instructs the communication unit 172 to acquire schedule information from the schedule database 107 (S50). The validity decision unit 136 decides whether or not there is agreement between the scheduled position at the time acquired in S40 of a physician corresponding to the ID stored in the ID storage unit 134 and the section acquired in S42 (S52). Without agreement (N of S52), the validity decision unit 136 decides the ID to be invalid. With agreement (Y of S52), the validity decision unit 136 decides the ID to be valid (S54).

The present invention has been explained based on the embodiments. It is understood that the invention is not limited to the embodiments and various modifications are also effective as the embodiments of the present invention.

In the present embodiments, the physician ID and the patient ID have been presented as example of IDs; however, a file by way of a patient's case record may be generated by combining nurse ID, pharmacist ID and the like therewith. When an image is taken not only in medical facilities but also at a construction site, the scene of an accident, or the like, IDs for identifying the place, time, person in charge of an insurance company, police officer, and the image-taker may be image-taken also.

It is expected that the IC tags in RFID (Radio Frequency Identification) and the like will see wider use in the years to come. However, the embodiments of the present invention have a merit that it is not necessary to provide the camera with a hardware mechanism for RFID. Since an affected part file is generated simply with the user taking the images of a bar code and a subject, there is no need for any additional steps that may complicate the intuitive user interface intrinsic to the camera. Also, since arrangements based on the time and position as well as the schedule of the image-taker and the patient are made to avoid any mistaken correspondence between the ID and the affected part photograph, the present embodiments may be suitably used in places for medical services and the like.

### INDUSTRIAL APPLICABILITY

The present invention is effective in making a record with a subject image and the information related to the subject combined with each other.

1-15. (canceled)

16. A digital camera, comprising:
an image pickup unit;
a graphic recording unit which records a graphic image indicating ID information based on a predetermined rule, among images picked up by said image pickup unit;
an ID acquisition unit which identifies the ID information indicated by the recorded graphic image, based on the predetermined rule;
an entity information requesting unit which transmits entity requesting information for requesting entity information corresponding to said identified ID information, to an external database that stores ID information and entity information by associating said ID information with the entity information identified thereby;
an entity information receiver which receives the entity information associated with the identified ID information from the external database;
an entity information displaying unit which displays the received entity information on a screen; and
a subject information recording unit which records subject information associating an image of a subject, picked up in connection with the entity information displayed on the screen, with both or either of the ID information and the entity information.

17. A digital camera, comprising:
an image pickup unit;
a graphic recording unit which records a graphic image indicating ID information based on a predetermined rule, among images picked up by said image pickup unit;
an ID acquisition unit which identifies the ID information indicated by the recorded graphic image, based on the predetermined rule;
an entity information acquisition unit which acquires entity information corresponding to said identified ID information, by referring to an entity information table where the ID information and the entity information are associated with each other;
an entity information displaying unit which displays the acquired entity information on a screen; and
a subject information recording unit which records subject information associating an image of a subject, picked up in connection with the entity information displayed on the screen, with both or either of the ID information and the entity information.

18. A digital camera according to claim 16, wherein said subject information recording unit records an image of the subject picked up immediately after the entity information has been displayed on said entity information displaying unit, by associating the subject image with both or either of the ID information and the entity information.

19. A digital camera according to claim 17, wherein said subject information recording unit records an image of the subject picked up immediately after the entity information has been displayed on said entity information displaying unit, by associating the subject image with both or either of the ID information and the entity information.

20. A digital camera according to claim 16, wherein said subject information recording unit records, as the subject information, the image of the subject added with both or either of the ID information and the entity information.

21. A digital camera according to claim 17, wherein said subject information recording unit records, as the subject information, the image of the subject added with both or either of the ID information and the entity information.

22. A digital camera according to claim 16, wherein said subject information recording unit records the subject information in an external recording medium via a network.

23. A digital camera according to claim 17, wherein said subject information recording unit records the subject information in an external recording medium via a network.

24. A digital camera according to claim 16, further comprising a differential time calculation unit which calculates a time difference between time at which the graphic image was recorded and time at which the subject information is to be recorded,
wherein said subject information recording unit records the subject information on the condition that the differential time is less than or equal to a predetermined value.

25. A digital camera according to claim 17, further comprising a differential time calculation unit which calculates a time difference between time at which the graphic image was recorded and time at which the subject information is to be recorded,
wherein said subject information recording unit records the subject information on the condition that the differential time is less than or equal to a predetermined value.

26. A digital camera according to claim 24, wherein said differential time calculation unit calculates, as a differential time, a time difference between time at which the ID information was identified and time at which the subject information is to be recorded.

27. A digital camera according to claim 25, wherein said differential time calculation unit calculates, as a differential time, a time difference between time at which the ID information was identified and time at which the subject information is to be recorded.

28. A digital camera according to claim 16, further comprising:
a position acquisition unit which acquires a position of said digital camera; and
a differential distance calculation unit which calculates, as a differential distance, a distance between a position at which time the graphic image was recorded and a position at which time the subject information is to be recorded,
wherein said subject information recording unit records the subject information on the condition that the differential distance is less than or equal to a predetermined value.

29. A digital camera according to claim 17, further comprising:
a position acquisition unit which acquires a position of said digital camera; and
a differential distance calculation unit which calculates, as a differential distance, a distance between a position at which time the graphic image was recorded and a position at which time the subject information is to be recorded,
wherein said subject information recording unit records the subject information on the condition that the differential distance is less than or equal to a predetermined value.

30. A digital camera according to claim 28, wherein said differential distance calculation unit calculates, as the differential distance, a distance between a position at which time the ID information was identified and a position at which time the subject information is to be recorded.

31. A digital camera according to claim 29, wherein said differential distance calculation unit calculates, as the differential distance, a distance between a position at which time the ID information was identified and a position at which time the subject information is to be recorded.

32. A digital camera according to claim 28, wherein said position acquisition unit includes:
a base-station detection unit which detects a base station in charge of a cell area including said digital camera;
an address receiver which receives a base-station address of the base station detected;
a position information requesting unit which transmits position request information to request position request information of a base station corresponding to the received base-station address, to an external database which stores base-station information in which the base-station address is associated with positional information on the base station; and
a positional information receiver which receives the positional information from the external database,
wherein the received positional information is acquired as the position of said digital camera.

33. A digital camera according to claim 29, wherein said position acquisition unit includes:
a base-station detection unit which detects a base station in charge of a cell area including said digital camera;
an address receiver which receives a base-station address of the base station detected;
a position information requesting unit which transmits position request information to request position request information of a base station corresponding to the received base-station address, to an external database which stores base-station information in which the base-station address is associated with positional information on the base station; and
a positional information receiver which receives the positional information from the external database,
wherein the received positional information is acquired as the position of said digital camera.

34. A digital camera, comprising:
an image pickup unit;
a graphic recording unit which records, among images picked up by said image pickup unit, a graphic image indicating ID information based on a predetermined rule;
an ID acquisition unit which identifies the ID information by the recorded graphic image, based on the predetermined rule; and
a subject information recording unit which records an image of a subject picked up by said image pickup unit and subject information that corresponds to the ID information.

35. A digital camera according to claim 16, wherein when one or more subject image is picked up between time when a first graphic image has been picked up and time when a second graphic image is newly picked up, said subject information recording unit records ID information indicated by the first graphic image and the subject images, as the subject information, in a manner that the first graphic image and the subject images are associated with each other.

36. A digital camera according to claim 17, wherein when one or more subject image is picked up between time when a first graphic image has been picked up and time when a second graphic image is newly picked up, said subject information recording unit records ID information indicated by the first graphic image and the subject images, as the subject information, in a manner that the first graphic image and the subject images are associated with each other.

37. A digital camera according to claim 34, wherein when one or more subject image is picked up between time when a first graphic image has been picked up and time when a second graphic image is newly picked up, said subject information recording unit records ID information indicated by the first graphic image and the subject images, as the subject information, in a manner that the first graphic image and the subject images are associated with each other.

38. A digital camera according to claim 16, wherein the ID information is information to identify a physician or patient and the subject image is an image of an affected part.

39. A digital camera according to claim 17, wherein the ID information is information to identify a physician or patient and the subject image is an image of an affected part.

40. A digital camera according to claim 34, wherein the ID information is information to identify a physician or patient and the subject image is an image of an affected part.

41. An image pickup method, comprising:
picking up an image of a graphic indicating ID information based on a predetermined rule;
recording the picked-up graphic image in a recording medium;
identifying the ID information indicated by the graphic recorded as the graphic image, based on the predetermined rule;
picking up an image of a subject; and
recording the picked-up subject image and the subject information that corresponds to the ID information,
wherein said recording the subject information is such that when a new graphic is picked up, ID information identified from the new graphic is recorded by associating the ID information with an image of the subject picked up after the new graphic has been picked up.

42. An image pickup method according to claim 41, wherein when one or more subject image is picked up between time when a first graphic image has been picked up and time when a second graphic image is newly picked up, ID information indicated by the first graphic image and the subject images are recorded as the subject information in a manner that the first graphic image and the subject images are associated with each other.
